(19) United States
(12) Patent Application Publication
(10) Pub. No.: US 2016/0073306 A1
(43) Pub. Date: Mar. 10, 2016

(54) WIRELESS NETWORK MEASUREMENT SCHEDULING

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/479,773

(22) Filed: Sep. 8, 2014

(51) Int. Cl. H04W 36/00; H04W 76/04; H04W 24/10

(52) U.S. Cl. CPC H04W 36/0088; H04W 24/10; H04W 76/048

(57) ABSTRACT

A user equipment (UE) camped on a first RAT and in a coverage area of a second RAT searches for one or more frequencies of the second RAT and measures one or more detected cells corresponding to the one or more frequencies of the second RAT. When the measurement indicates that cell reselection/handover trigger conditions are met the UE starts a cell reselection timer or time to trigger. The UE schedules a measurement of the neighbor cell during a time instance close to when the reselection timer or time to trigger expires.

### BACKGROUND

1. Field

Aspects of the present disclosure relate generally to wireless communication systems, and more particularly, to scheduling of measurements of neighbor cells/frequencies.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes starting a timer when a signal strength of a neighbor cell is determined to exceed a threshold. The method also includes scheduling a measurement of the neighbor cell during a time instance based on when the timer expires.

According to another aspect of the present disclosure, an apparatus for wireless communication includes means for starting a timer when a signal strength of a neighbor cell is determined to exceed a threshold. The apparatus also include means for scheduling a measurement of the neighbor cell during a time instance based on when the timer expires.

Another aspect discloses a computer program product for wireless communications in a wireless network having a non-transitory computer-readable medium. The computer readable medium has non-transitory program code recorded thereon which, when executed by the processor(s), causes the processor(s) to perform an operation of starting a timer when a signal strength of a neighbor cell is determined to exceed a threshold. The program code also causes the processor(s) to schedule a measurement of the neighbor cell during a time instance based on when the timer expires.

Another aspect discloses an apparatus for wireless communication and includes a memory and at least one processor coupled to the memory. The processor(s) is configured to start a timer when a signal strength of a neighbor cell is determined to exceed a threshold. The processor(s) is also configured to schedule a measurement of the neighbor cell during a time instance based on when the timer expires.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 illustrates an inter radio access technology measurement schedule and corresponding cell reselection timer for cell reselection during discontinuous reception cycles.

FIGS. 6A and 6B illustrate inter radio access technology measurement schedules for cell reselection during discontinuous reception cycles according to aspects of the present disclosure.

FIGS. 7A and 7B illustrate inter radio access technology measurement schedules for handover according to aspects of the present disclosure.

FIG. 8 shows a wireless communication method according to one aspect of the present disclosure.

FIG. 9 is a diagram illustrating an example of a hardware implementation for an apparatus employing a processing system according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

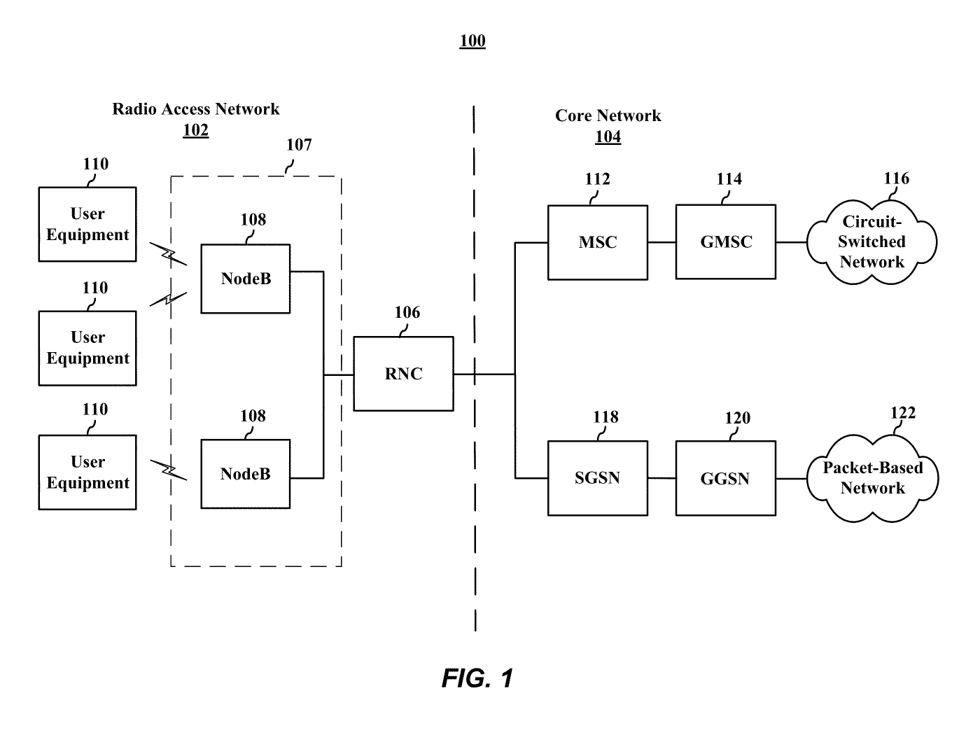

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

General packet radio service (GPRS) is designed to provide packet-data services at speeds higher than those available with standard GSM circuit switched data services. The core network 104 also supports packet-data services with a serving GPRS support node (SGSN) 118 and a gateway GPRS support node (GGSN) 120. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

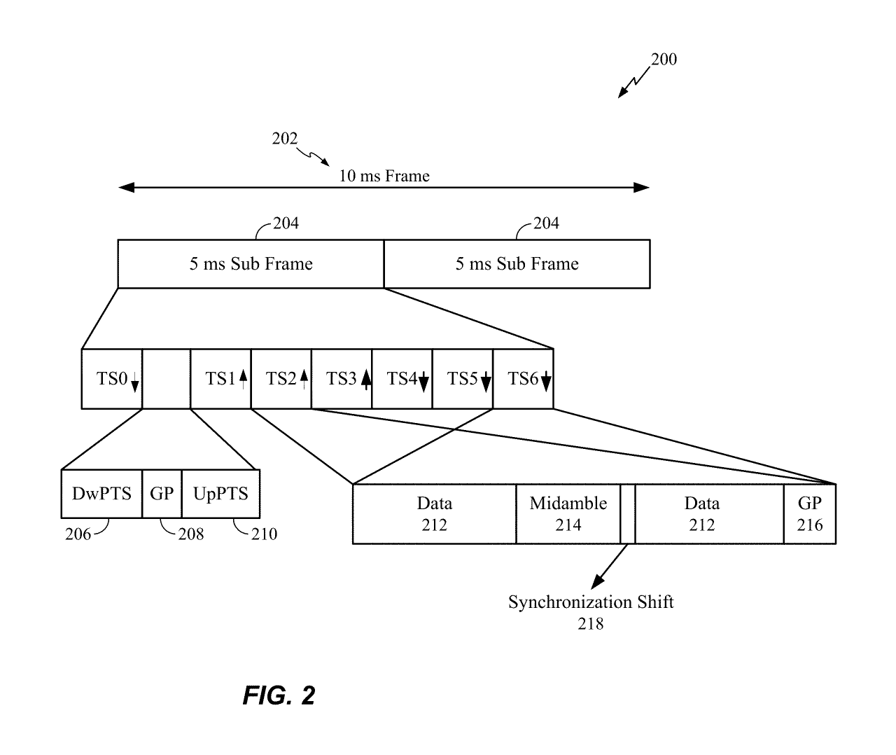

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization Shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

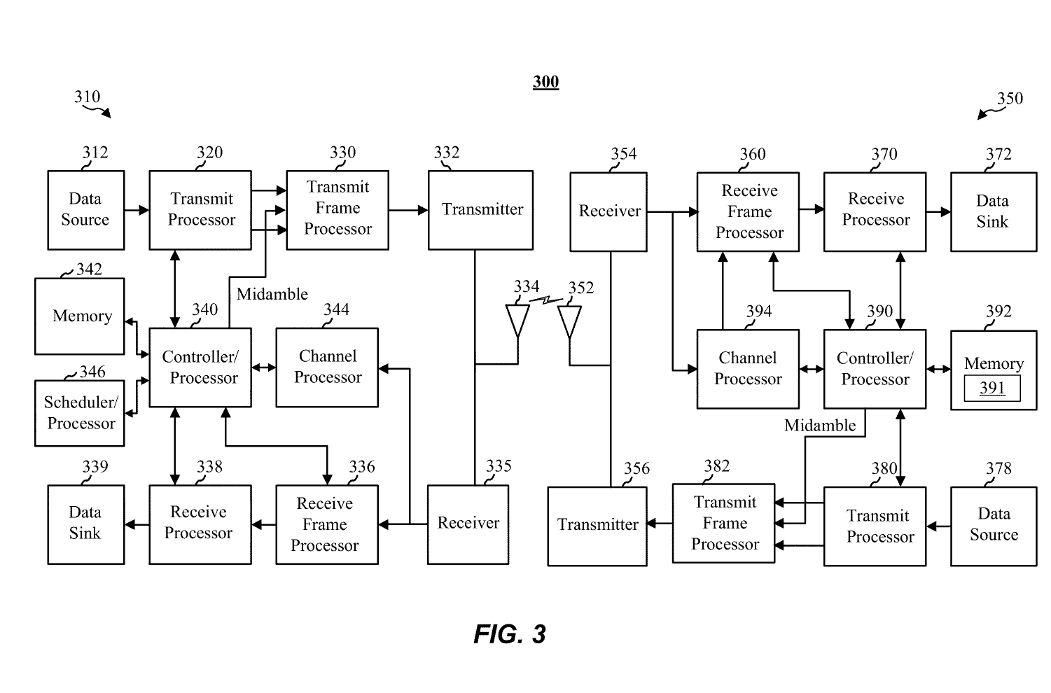

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a measurement module 391 which, when executed by the controller/processor 390, configures the UE 350 for cell reselection. A scheduler/processor 346 at the node B 310 may be used to allocate resources to the UEs and schedule downlink and/or uplink transmissions for the UEs.

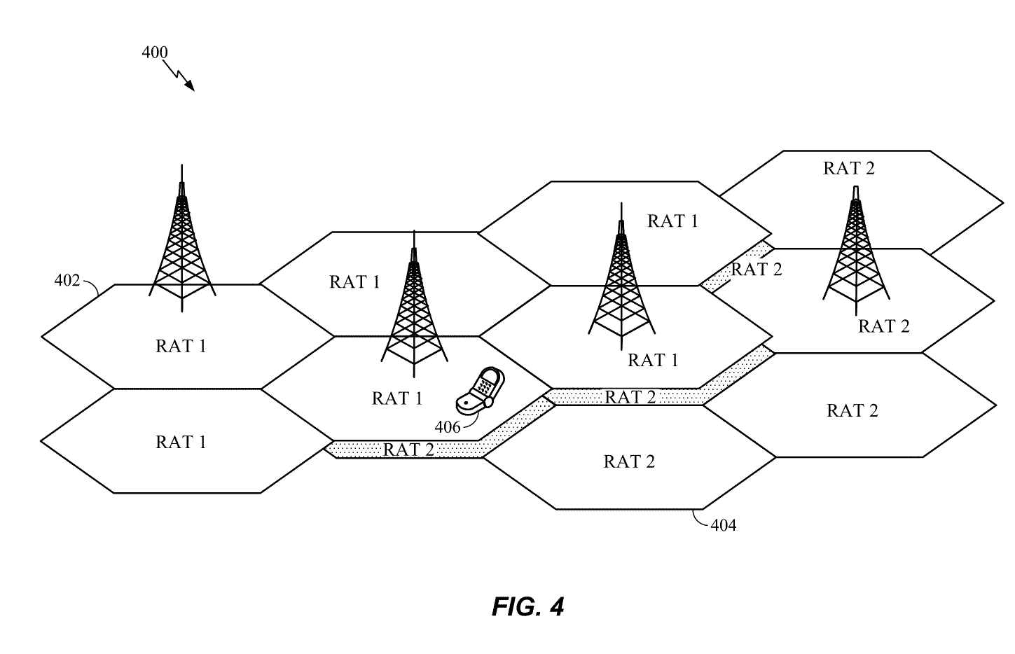

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (RAT-1), such as GSM, TD-SCDMA or Long Term Evolution (LTE) and also illustrates a newly deployed network utilizing a second type of radio access technology (RAT-2), such as a GSM, TD-SCDMA or Long Term Evolution (LTE). Those skilled in the art will appreciate that the network may contain more than two types of RATs. For example, the geographical area 400 may also include a third RAT, such as, but not limited to GSM, TD-SCDMA or Long Term Evolution (LTE).

The geographical area 400 may include RAT-1 cells 402 and RAT-2 cells 404. In one example, the RAT-1 cells are TD-SCDMA/GSM cells and the RAT-2 cells are LTE cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

In a system having multiple radio access technologies (RATs), there are times when a particular UE will operate on one system and then switch to another system. Such a switching between systems is called an inter-radio access technology (IRAT) handover (HO) or reselection between the two systems. Such handovers or reselections may be performed, e.g., for load balancing purposes, coverage holes in one network, or can be based on the type of communication desired by the UE.

The handover or cell reselection may be performed when the UE moves from a coverage area of a first type of RAT to the coverage area of a second type RAT, or vice versa. A handover or cell reselection may also be performed when there is a coverage hole or lack of coverage in one network or when there is traffic balancing between the networks of the different types of RATs.

As part of that handover or cell reselection process, while in a connected mode or discontinuous reception (DRX) mode with a first RAT (e.g., GSM, LTE or TD-SCDMA), a user equipment (UE) may be specified to perform activities at a second RAT (e.g., GSM, LTE or TD-SCDMA). The DRX mode may include idle mode, cell paging channel (CELL_PCH) mode, and universal terrestrial radio access network (UTRAN) registration area paging channel (URA_PCH) mode.

The UE operating in DRX mode may periodically enter an active state during which it may receive messages on a paging channel from the base stations with which it has previously established communication. For example, the UE may awaken from an inactive state prior to its assigned frame, monitor the paging channels for messages, and revert to the inactive state if additional communication is not desired. The time between two consecutive paging messages is called a DRX cycle.

Further, the UE may tune away from the first RAT to perform the activities at the second RAT while in a connected mode or DRX mode. The activity performed when tuning away may include selecting and monitoring an indicated paging indicator channel (PICH) and paging channel (PCH), monitoring for paging information of the second RAT, monitoring and collecting system information of the second RAT (e.g., frequency of the second RAT), performing measurements (e.g., inter radio access technology measurements) for cells/frequencies of the first RAT and neighbor cells of the second RAT, executing cell reselection evaluation processes, and/or performing cell reselection to reselect to a neighbor cell of the second RAT when cell reselection trigger conditions are met. Whether the trigger conditions are met is based on the results of the activities performed (e.g., inter radio access technology (IRAT) measurement).

For example, the cell reselection trigger conditions may be satisfied when neighbor frequencies of the second RAT (e.g., LTE) have higher priority than frequencies of the serving first RAT (e.g., GSM or TD-SCDMA) and a signal quality of a detected cell of the second RAT is above a threshold defined by the first RAT. In addition, the cell reselection trigger conditions are met when the second RAT neighbor frequencies have lower priority than that of the first RAT and the signal quality of the serving first RAT is below a threshold and the signal quality of a detected neighbor cell of the second RAT is above a threshold.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc. Signal quality is intended to cover the term signal strength, as well.

In some networks, when the UE is camped on or connected to a serving cell of a first RAT, the UE may be informed of multiple neighbor cells. The neighbor cells may be of a same RAT and may have different frequencies or be of different RATs with same and/or different frequencies. For example, the UE may receive or be informed of LTE neighbor frequencies/cells with or without cell identifiers while camped on a TD-SCDMA cell. The neighbor cell information may be broadcast from a network (e.g., TD-SCDMA network). In some instances, only frequencies of a particular RAT (e.g., LTE) are broadcasted to the UE.

In accordance with the reselection procedure, the UE performs radio access technology measurements on neighbor cells (e.g., LTE neighbor cells/frequencies). Some of the measurements include measurements of received signal code power (RSCP) for a primary common control physical channel (P-CCPCH) of an inter frequency neighbor. For example, the UE may perform measurements of LTE neighbor frequencies that have higher priority or lower priority than the TD-SCDMA serving cell when a signal strength of the TD-SCDMA serving cell is below a threshold indicated by the TD-SCDMA network.

The measurements may be periodic or occur at specified time periods, during certain situations, or in response to conditions that trigger the measurements. For example, according to some network specifications (e.g., 3GPP), the UE may perform measurement of LTE cells according to a schedule. An exemplary measurement schedule is illustrated in Table 1.

TABLE 1
Cell Measurement Scheduling

| | Scheduled EUTRA Cell Measurement Attempt from |
|---|---|
| DRX Cycle | TD-SCDMA; One cell measurement attempt per |
| Length (seconds) | number of DRX cycle |
| 0.08 | K_carrier * 2.56 s (32 DRX cycle) |
| 0.16 | K_carrier * 2.56 s (16 DRX cycle) |
| 0.32 | K_carrier * 5.12 s (16 DRX cycle) |
| 0.64 | K_carrier * 5.12 s (8 DRX cycle) |
| 1.28 | K_carrier * 6.4 s (5 DRX cycle) |
| 2.56 | K_carrier * 7.68 s (3 DRX cycle) |
| 5.12 | K_carrier * 10.24 s (2 DRX cycle) |

In some implementations, single cell measurements may be attempted for a specified number of DRX cycles. For example, cell measurements may be performed for a single frequency of a carrier that corresponds to an evolved absolute radio frequency channel number (EARFCN) for the specified number of DRX cycles. The EARFCN are radio access technology (e.g., LTE) carrier channel numbers that are used by a network to define a carrier frequency. For example, when K_carrier, which corresponds to a frequency number, is one, and the length of the DRX cycle is 1.28 seconds, the cell measurements may be performed or scheduled every five DRX cycles (i.e., every 6.4 seconds divided by 1.28 seconds).

During the measurements, if the cell reselection trigger conditions are continuously met upon the expiration of a reselection timer (e.g., Treselection), the serving RAT informs the target RAT to initiate cell reselection to a detected cell of the target RAT during the measurements. The reselection timer governs when a UE may reselect to a new cell. The UE may not be permitted to reselect to a desired target RAT until expiration of the timer. Thus, the UE reselects to the target cell if the cell reselection trigger conditions are continuously met until expiration of the reselection timer. For example, a TD-SCDMA module of the UE informs an LTE module of the UE to start cell reselection to the target LTE cell/frequency detected during the measurements. The LTE module of the UE then starts acquisition on the LTE frequency of the detected target LTE cell. The LTE module then attempts to camp on the target LTE cell after collection of broadcasted system information blocks (SIBs).

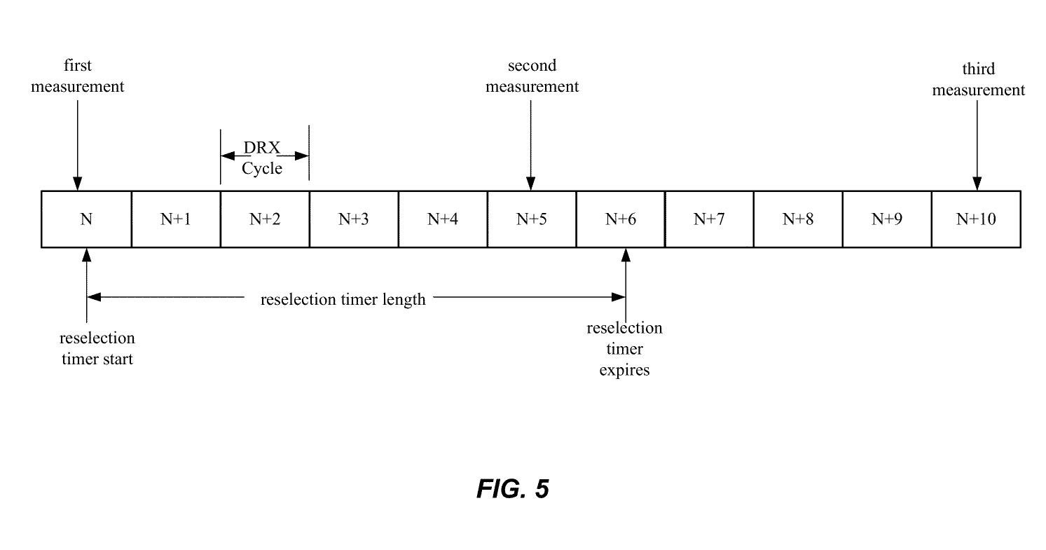

FIG. 5 illustrates a radio access technology measurement schedule and corresponding cell reselection timer for cell reselection during multiple DRX cycles (e.g., N, N+1, N+2, N+3, . . . N+10). As noted, the measurements may be periodic or based on a specified schedule. For example, the measurements may be scheduled every five DRX cycles such that the measurements are performed in DRX cycles N, N+5 and N+10.

When the result of the measurements is available, the UE performs cell reselection when the trigger conditions are continuously met and the cell reselection timer has expired. However, completion of scheduled measurements may not coincide with an expiration of a reselection timer. As a result, the cell reselection may be delayed to a next scheduled measurement that is after the expiration of the reselection timer.

For example, if the UE performs a first measurement in DRX cycle N and the result of the first measurement indicates that the trigger conditions are met, the UE starts a reselection timer (e.g., in DRX cycle N). As noted, the expiration of the reselection timer may not coincide with the measurement schedule. For example, the UE may be scheduled to perform a second measurement in the DRX cycle N+5 but the cell reselection timer expires in the DRX cycle N+6. In this case, the second measurement does not trigger the cell reselection (e.g., from TD-SCDMA to LTE) because the cell reselection timer has not expired. As a result, the cell reselection is delayed until a third measurement in the DRX cycle N+10.

### Cell Measurement Scheduling

Aspects of the present disclosure are directed to cell reselection or handover from a first radio access technology (RAT) (or frequency) to a second RAT (and/or frequency), when scheduled radio access technology measurements do not coincide with expiration of a reselection timer or time to trigger. In one aspect of the present disclosure, when a user equipment (UE) is camped on the first RAT and the UE is in a coverage area of the second RAT, the UE searches for one or more frequencies of the second RAT and measures one or more detected cells corresponding to the one or more frequencies of the second RAT. When results of the measurements indicate that cell reselection/handover trigger conditions are met, the UE starts a cell reselection timer or time to trigger. For example, the UE starts a timer when a signal quality of a neighbor cell of the second RAT is determined to exceed a threshold. The UE then schedules actual measurements during a time instance when the reselection timer or time to trigger expires. For example, the actual measurements may be scheduled in a same DRX cycle or measurement gap that coincides with the expiration of the reselection timer or the time to trigger. In another configuration, the measurement occurs shortly after the expiration.

In one aspect of the present disclosure, scheduling the actual measurements to coincide with the expiration of the reselection timer includes adjusting a timing of the scheduled or periodic measurement. For example, the scheduled measurement may be advanced or delayed to coincide with a timing of when the reselection timer expires.

In one aspect of the disclosure, the UE schedules additional measurements that coincide with the expiration of the reselection timer. For example, the UE maintains originally scheduled measurements that are staggered in time from the time instance that the reselection timer expires. However, in addition to the originally scheduled measurements, the UE performs extra measurements at time instances that coincide with the expiration of the reselection timer.

In one aspect of the present disclosure, the extra and scheduled measurements are performed during time instances between a series of time instances of a wireless communication mode. For example, the time instance may include a number of DRX cycles when the UE is in an idle mode. In another aspect of the disclosure, the time instance corresponds to a number of radio frames or a number of measurement gaps when the UE is in a connected mode.

As noted, the actual measurements may be performed in a time instance that coincides with the expiration of a timer that governs when a UE may reselect or handover to a new cell. When the UE is in the idle mode, the timer is a reselection timer. However, when the UE is in a connected mode, the timer is a time to trigger that governs when a UE may handover to a new cell.

As noted, when the UE is camped on or connected to a serving cell of a first RAT, the UE may be informed of multiple neighbor cells. The neighbor cells may be of a same RAT and may have different frequencies or the neighbor cells may be of different RATs with same and/or different frequencies.

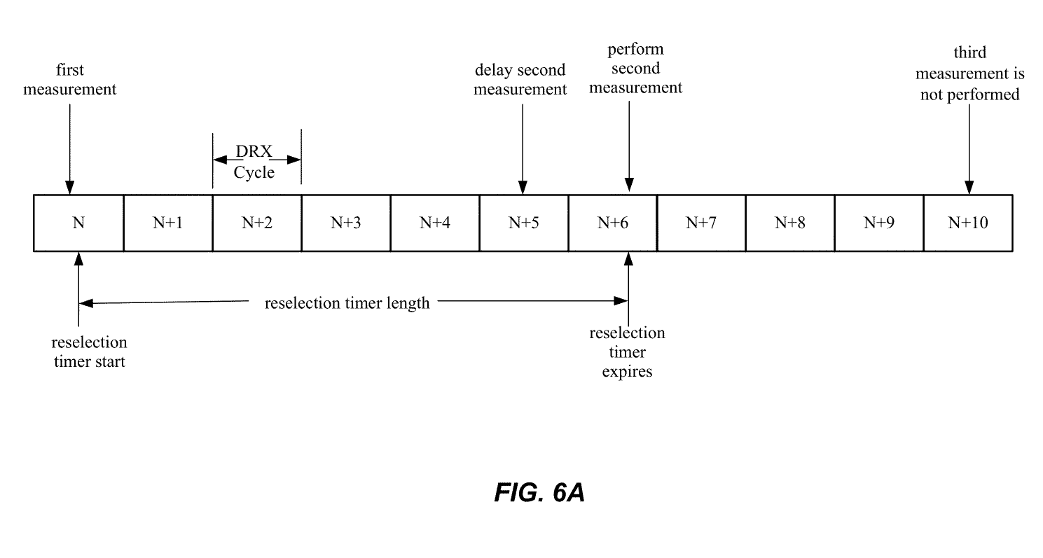

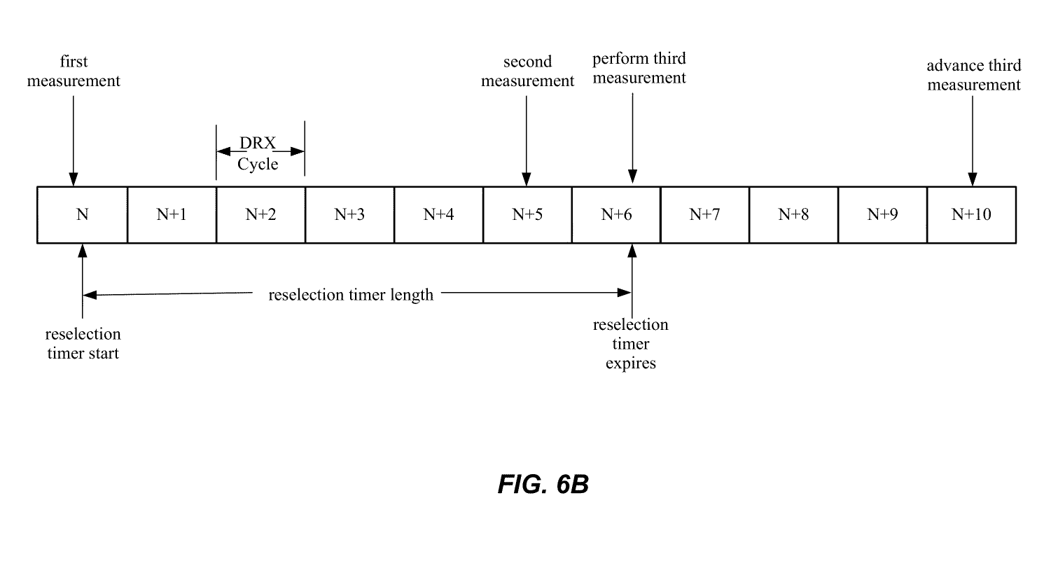

FIGS. 6A and 6B illustrate radio access technology measurements for cell reselection during DRX cycles according to aspects of the present disclosure. For explanatory purposes, FIGS. 6A and 6B are discussed with reference to the timeline of FIG. 5. Although measurements illustrated in FIGS. 6A and 6B may be scheduled periodically as in FIG. 5, in FIGS. 6A and 6B, the UE adjusts the timing of the scheduled measurements to coincide with expiration of the reselection timer.

For example, in FIG. 6A, rather than perform the second measurement in the DRX cycle N+5, the UE delays the second measurement to coincide with the expiration of the reselection timer. That is, the UE performs the second measurement in the same DRX cycle N+6 that corresponds to the time instance at which the reselection timer expires. As a result, the UE may avoid performing the third measurement when the UE determines, in the DRX cycle N+6, that the trigger conditions are met upon expiration of the reselection timer. That is, the cell reselection occurs in DRX cycle N+6 instead of in DRX cycle N+10 and the UE only performs one measurement in the DRX cycle N+6. However, the UE may perform the third measurement when the results of the second measurement indicate that the trigger conditions are not met.

As shown in FIG. 6B, in some aspects of the disclosure, the UE may not delay performing the second measurement. Rather, the UE may advance the third measurement that was initially scheduled to be performed in DRX cycle N+10. For example, the UE performs the third measurement in the same DRX cycle N+6 that corresponds to the time instance in which the reselection timer expires.

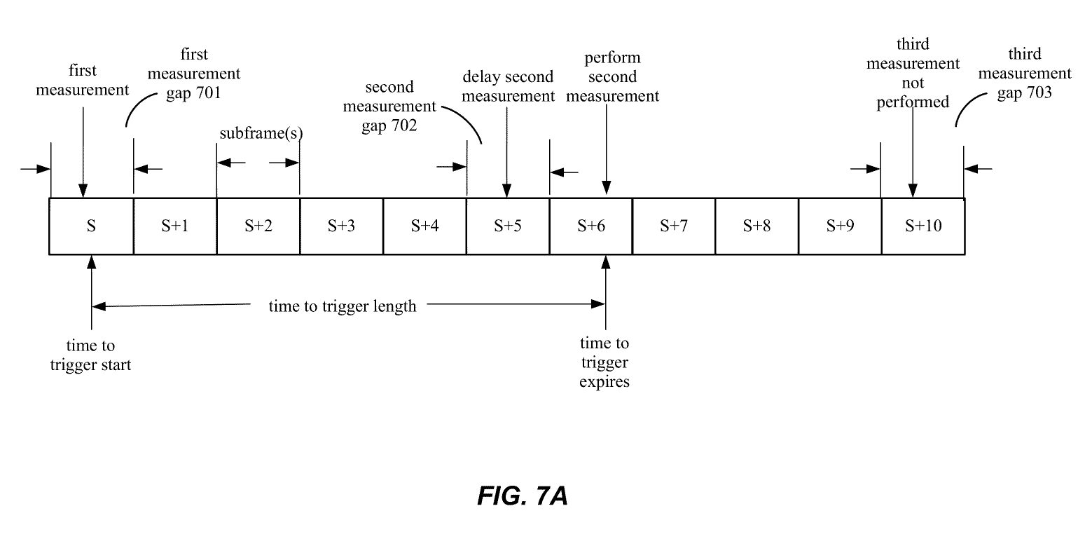

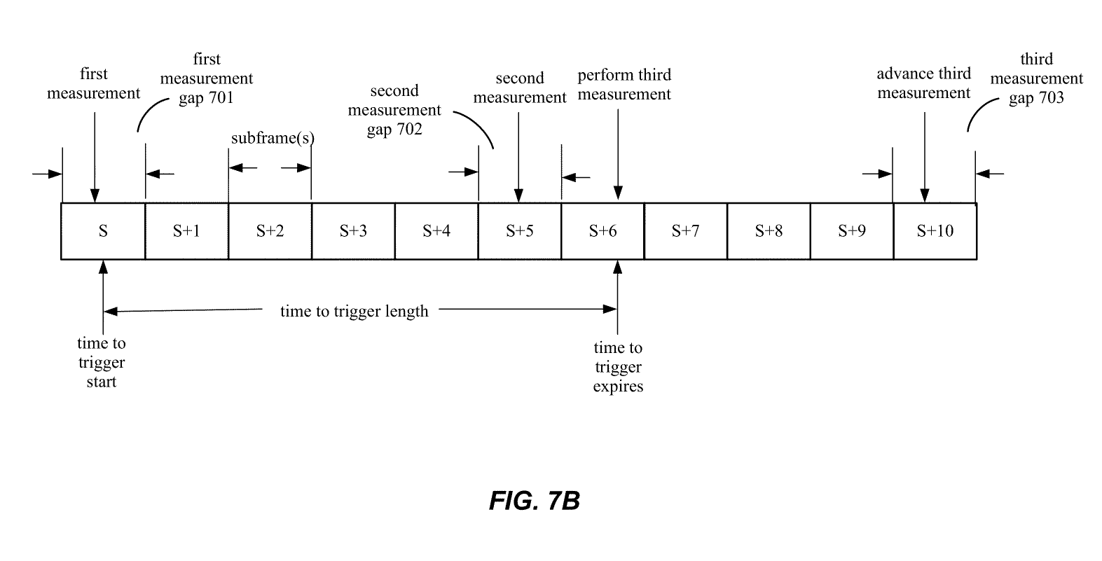

FIGS. 7A and 7B illustrate radio access technology measurements for handover according to aspects of the present disclosure. As part of the handover, while in a connected mode with a first RAT, a UE may be specified to perform radio access technology measurements of neighboring cells in measurement gaps. The measurement gaps may include one or more subframes configured by a network. In one aspect of the disclosure, each measurement gap may be an idle interval or a dedicated channel measurement occasion. Similar to the scheduled measurements discussed with respect to cell reselection, the measurement gaps may be scheduled periodically. As a result, the scheduled measurement gaps may be subject to handover delay that is similar to cell reselection delay discussed with respect to FIG. 5.

In one aspect of the disclosure, the measurement gaps may be adjusted to coincide with the expiration of a time to trigger that governs when a UE may handover to a new cell. The measurement gap(s) may correspond to an identified number of radio subframes of a set of radio subframes for communication in the connected mode. The set of subframes S, S+1, S+2, S+3, . . . S+10 may be available to the UE for communication in the connected mode. Some of the subframes are scheduled measurement gaps 701, 702, 703 that are allocated to the UE by the network for measurements.

The time to trigger may be initiated after a first measurement in a first measurement gap 701 and expires in subframe S+6 that is not a scheduled measurement gap. However, the second measurement in the second measurement gap 702 occurs before the expiration of the time to trigger.

According to aspects of the present disclosure illustrated in FIG. 7A, the UE delays the second measurement scheduled to be performed in the second measurement gap 702 to coincide with the expiration of the time to trigger in subframe S+6. That is, the UE performs the second measurement in the same subframe(s) S+6 that corresponds to the time instance in which the time to trigger expires.

According to aspects of the present disclosure illustrated in FIG. 7B, the UE may not delay performing the second measurement. Rather, the UE may advance performing the third measurement that was initially scheduled to be performed in the third measurement gap 703. For example, the UE performs the third measurement in the same subframe(s) S+6 that corresponds to the time instance in which the time to trigger expires.

Aspects of the present disclosure speed up the reselection or handover procedure to a neighbor RAT and reduce the number of measurements performed to improve battery life.

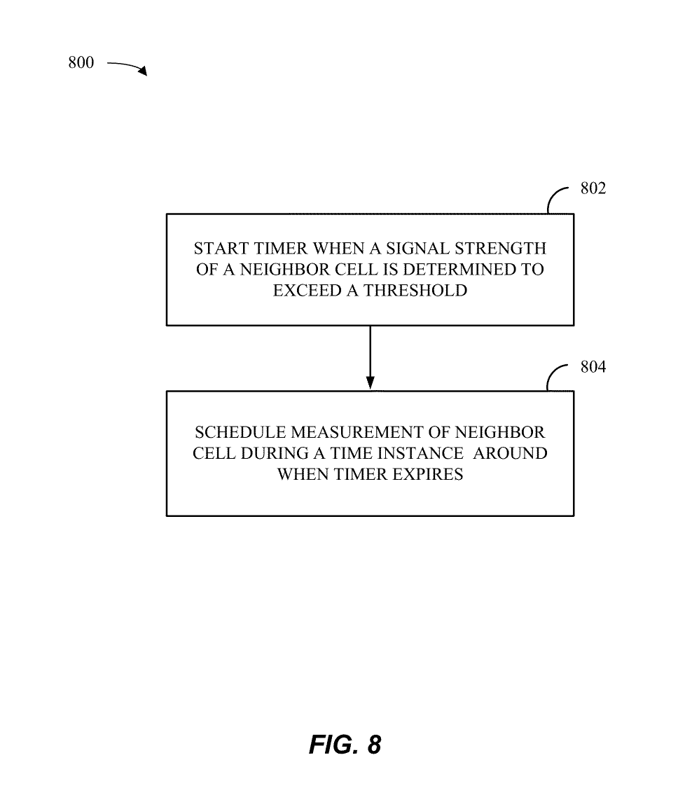

FIG. 8 shows a wireless communication method 800 according to one aspect of the disclosure. In this example, the IRAT measurement may be periodic or based on a specified schedule configured by a network. A UE starts a timer when a signal strength of a neighbor cell is determined to exceed a threshold, as shown in block 802. The UE adjusts the periodic measurement schedule by scheduling a measurement of the neighbor cell during a time instance when the timer expires, as shown in block 804. In another configuration, the measurement schedule is adjusted so that the measurement occurs shortly after the timer expires.

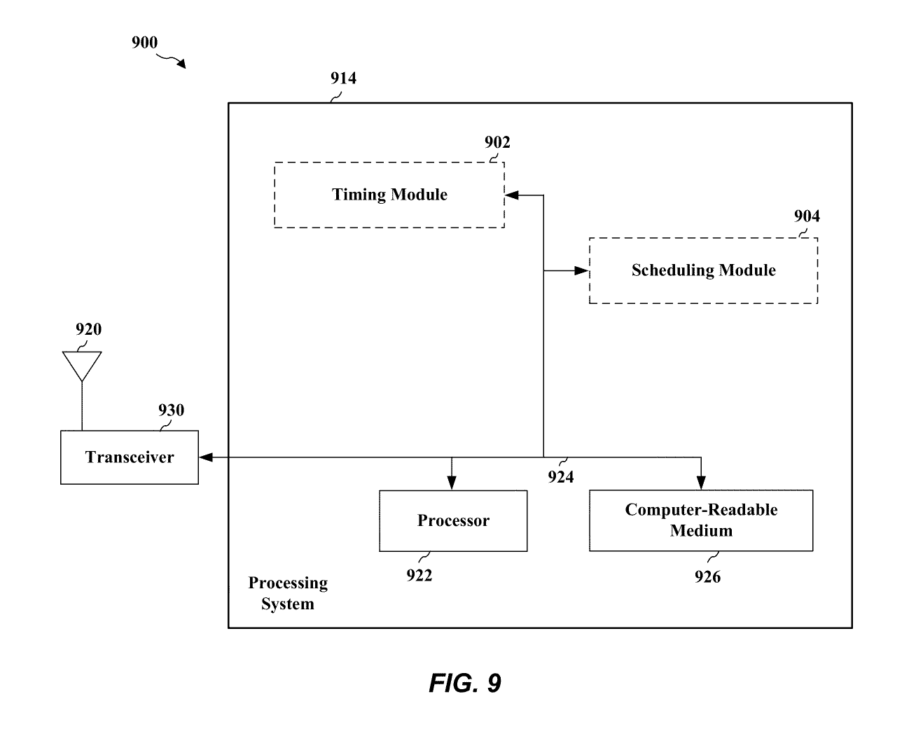

FIG. 9 is a diagram illustrating an example of a hardware implementation for an apparatus 900 employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware modules, represented by the processor 922 the modules 902, 904 and the non-transitory computer-readable medium 926. The bus 924 may also link various other circuits such as timing sources, peripherals, voltage regulators, and power management circuits, which are well known in the art, and therefore, will not be described any further.

The apparatus includes a processing system 914 coupled to a transceiver 930. The transceiver 930 is coupled to one or more antennas 920. The transceiver 930 enables communicating with various other apparatus over a transmission medium. The processing system 914 includes a processor 922 coupled to a non-transitory computer-readable medium 926. The processor 922 is responsible for general processing, including the execution of software stored on the computer-readable medium 926. The software, when executed by the processor 922, causes the processing system 914 to perform the various functions described for any particular apparatus. The computer-readable medium 926 may also be used for storing data that is manipulated by the processor 922 when executing software.

The processing system 914 includes a timing module 902 for starting a timer when a signal strength of a neighbor cell is determined to exceed a threshold. The processing system 914 includes a scheduling module 904 for scheduling a measurement of the neighbor cell during a time instance around when the timer will expire. The modules may be software modules running in the processor 922, resident/stored in the computer-readable medium 926, one or more hardware modules coupled to the processor 922, or some combination thereof. The processing system 914 may be a component of the UE 350 and may include the memory 392, and/or the controller/processor 390.

In one configuration, an apparatus such as a UE is configured for wireless communication including means for starting a timer. In one aspect, the timer starting means may be the antennas 352/920, the receiver 354, the transceiver 930, the channel processor 394, the receive frame processor 360, the receive processor 370, the controller/processor 390, the memory 392, the measurement module 391, the timing module 902, and/or the processing system 914 configured to perform the aforementioned means. The UE is also configured to include means for scheduling a measurement. In one aspect, the measurement scheduling means may be the antennas 352/920, the receiver 354, the transceiver 930, the channel processor 394, the receive frame processor 360, the receive processor 370, the controller/processor 390, the memory 392, measurement module 391, the scheduling module 904 and/or the processing system 914 configured to perform the aforementioned means. In one configuration, the means functions correspond to the aforementioned structures. In another aspect, the aforementioned means may be any module or any apparatus configured to perform the functions recited by the aforementioned means.

Several aspects of a telecommunications system have been presented with reference to LTE, TD-SCDMA and GSM systems. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising:
starting a timer when a signal strength of a neighbor cell is determined to exceed a threshold; and
scheduling a measurement of the neighbor cell during a time instance based at least in part on when the timer expires.

2. The method of claim 1, in which the scheduling comprises adjusting a timing of a periodic measurement to occur earlier or later.

3. The method of claim 1, in which the scheduling comprises scheduling an additional measurement.

4. The method of claim 1, in which the time instance comprises a number of discontinuous reception (DRX) cycles in an idle mode, a number of radio frames in connected mode, or a number of measurement gaps in connected mode.

5. The method of claim 4, in which the timer in idle mode is a reselection timer for cell reselections.

6. The method of claim 4, in which the timer in connected mode is a time to trigger for a measurement report of handover.

7. The method of claim 1, in which the neighbor cell is in the same or different frequency or Radio Access Technology (RAT).

8. An apparatus for wireless communication, comprising:
means for starting a timer when a signal strength of a neighbor cell is determined to exceed a threshold; and
means for scheduling a measurement of the neighbor cell during a time instance based at least in part on when the timer expires.

9. The apparatus of claim 8, in which the scheduling means comprises means for adjusting a timing of a periodic measurement to occur earlier or later.

10. The apparatus of claim 8, in which the scheduling means comprises means for scheduling an additional measurement.

11. The apparatus of claim 8, in which the time instance comprises a number of discontinuous reception (DRX) cycles in an idle mode, a number of radio frames in connected mode, or a number of measurement gaps in connected mode.

12. The apparatus of claim 11, in which the timer in idle mode is a reselection timer for cell reselections.

13. The apparatus of claim 11, in which the timer in connected mode is a time to trigger for a measurement report of handover.

14. The apparatus of claim 8, in which the neighbor cell is in the same or different frequency or Radio Access Technology (RAT).

15. An apparatus for wireless communication, comprising:
a memory; and
at least one processor coupled to the memory and configured:
to start a timer when a signal strength of a neighbor cell is determined to exceed a threshold; and
to schedule a measurement of the neighbor cell during a time instance based at least in part on when the timer expires.

16. The apparatus of claim 15, in which the at least one processor is further configured to schedule by adjusting a timing of a periodic measurement to occur earlier or later.

17. The apparatus of claim 15, in which the at least one processor is further configured to schedule an additional measurement.

18. The apparatus of claim 15, in which the time instance comprises a number of discontinuous reception (DRX) cycles in an idle mode, a number of radio frames in connected mode, or a number of measurement gaps in connected mode.

19. The apparatus of claim 18, in which the timer in idle mode is a reselection timer for cell reselections.

20. The apparatus of claim 18, in which the timer in connected mode is a time to trigger for a measurement report of handover.

21. The apparatus of claim 15, in which the neighbor cell is in the same or different frequency or Radio Access Technology (RAT).

22. A computer program product for wireless communication, comprising:
a non-transitory computer-readable medium having program code recorded thereon, the program code comprising:
program code to start a timer when a signal strength of a neighbor cell is determined to exceed a threshold; and
program code to schedule a measurement of the neighbor cell during a time instance based at least in part on when the timer expires.

23. The computer program product of claim 22, in which the computer program product further comprises program code to schedule by adjusting a timing of a periodic measurement to occur earlier or later.

24. The computer program product of claim 22, in which the computer program product further comprises program code to schedule an additional measurement.

25. The computer program product of claim 22, in which the time instance comprises a number of discontinuous reception (DRX) cycles in an idle mode, a number of radio frames in connected mode, or a number of measurement gaps in connected mode.

26. The computer program product of claim 25, in which the timer in idle mode is a reselection timer for cell reselections.

27. The computer program product of claim 25, in which the timer in connected mode is a time to trigger for a measurement report of handover.

28. The computer program product of claim 22, in which the neighbor cell is in the same or different frequency or Radio Access Technology (RAT).
